(19) United States
(12) Patent Application Publication
(10) Pub. No.: US 2026/0365193 A1
(43) Pub. Date: Nov. 19, 2026

(54) METHOD AND APPARATUS FOR GUIDING DRIVING BEHAVIOR

(71) Applicants: HYUNDAI MOTOR COMPANY, SEOUL (KR); KIA CORPORATION, SEOUL (KR)

(72) Inventors: Xueli Sun, Shandong (CN); Xin Liu, Shandong (CN); Xiao Yang Chu, Shandong (CN)

(73) Assignees: HYUNDAI MOTOR COMPANY, SEOUL (KR); KIA CORPORATION, SEOUL (KR)

(21) Appl. No.: 19/324,065

(22) Filed: Sep. 9, 2025

(30) Foreign Application Priority Data
May 13, 2025 (CN) 202510609872.6

(51) Int. Cl. B60W 50/14; B60W 40/09

(52) U.S. Cl. CPC B60W 50/14; B60W 40/09; B60W 2050/146; B60W 2520/105

(57) ABSTRACT

The present disclosure provides a method and apparatus for guiding driving behavior. The method may include obtaining a standard driving cycle of a vehicle and parameter values of driving characteristics of the standard driving cycle, obtaining parameter values of actual driving data with respect to the driving characteristics of the standard driving cycle during driving by a driver, evaluating driving behavior by comparing the parameter values of the driving characteristics of the standard driving cycle with the parameter values of the actual driving data with respect to the driving characteristics of the standard driving cycle, and guiding the driving behavior based on a result of the evaluation of the driving behavior. The present disclosure may evaluate the influence of a driver's driving behavior on vehicle energy consumption measured based on standard driving cycles, and guide the driving behavior based on the evaluation result.

### CROSS-REFERENCE TO RELATED APPLICATION(S)

This present application claims the benefit of priority to Chinese Patent Application No. 202510609872.6, filed on May 13, 2025, in the China National Intellectual Property Administration, the entire disclosure of which is incorporated herein by reference.

### TECHNICAL FIELD

The present disclosure relates to the field of automotive driver assistance technology, and particularly, to a method and apparatus for guiding driving behavior.

### BACKGROUND

A vehicle driving cycle describes a speed-time curve of a vehicle's driving, and may indicate driving characteristics for a particular type of vehicle on a particular section of road or in a particular area. Currently, various representative vehicle driving cycles are used worldwide. For example, some conventional driving cycles include the New European Driving Cycle (NEDC), the World Light Vehicle Test Cycle (WLTC), and the China Light-duty Vehicle Test Cycle (CLTC). For example, Chinese national standard GB/T 38146.1-2019 “China Automotive Test Cycle—Part 1: Light-duty Vehicles” defines the structure of a driving cycle for light-duty vehicles. FIG. 1 shows the speed-time curve of the China Light-duty Vehicle Test Cycle for Passenger Car (CLTC-P) driving cycle. A vehicle driving cycle serves as the basis for measuring vehicle energy consumption, driving range, and exhaust emissions, as well as for determining applicable regulatory limits. The vehicle driving cycle is also used as a reference in vehicle development and evaluation, and constitutes a useful shared foundational technology in the automotive industry.

The vehicle driving cycle forms the basis for methods of measuring energy consumption and driving range. For example, Chinese national standard GB/T 18386.1-2021, “Test Methods for Energy Consumption and Range of Electric Vehicles—Part 1: Light-duty Vehicles,” may provide the methods for measuring the energy consumption and driving range of electric vehicles. This standard specifies that the test cycle is based on the China Light-duty Vehicle Test Cycle (CLTC) driving cycle as set forth in Annex A of GB/T 38146.1-2019. FIG. 2 illustrates an automotive energy consumption label for a specific vehicle type. When the vehicle is sold, the energy consumption label shown in FIG. 2 is affixed to the windshield or a side window of the vehicle, thereby allowing consumers to receive relatively accurate information regarding the vehicle's energy consumption. As shown in FIG. 2, the electric vehicle of this type has a power consumption of 16.3 kW·h/100 km and a driving range of 530 km as measured according to the GB/T 18386.1-2021 standard.

However, a single representative driving cycle may not adequately reflect the complexity and variability of actual driving environments. In particular, the power consumption and driving range of electric vehicles are closely related to the vehicle's hardware and software, and also to the driver's driving behavior. The energy consumption specified based on a single representative driving cycle, using a publicly disclosed and fixed format, often shows a discrepancy from the energy consumption observed during actual vehicle operation. That is, when a user actually drives an electric vehicle of the type shown in FIG. 2, the actual power consumption may differ from 16.3 kWh/100 km (as shown) due to the influence of the driver's driving behavior. For the same reason, the actual driving range may also differ from 530 km.

Accordingly, it may be useful to address how to evaluate the impact of a driver's driving behavior on the vehicle's energy consumption, which is specified based on a representative driving cycle (hereinafter referred to as “certified energy consumption”).

This Background section is for enhancement of understanding of the background of the disclosure, and should not be taken as acknowledgement that the background corresponds to prior art already known to those skilled in the art.

### SUMMARY

The following summary presents a simplified summary of certain features. The summary is not an extensive overview and is not intended to identify key or critical elements.

The present disclosure is directed to providing a method and apparatus for guiding driving behavior. The method and apparatus may evaluate the influence of a driver's driving behavior on the energy consumption of a vehicle as measured based on a standard driving cycle, and may guide the driving behavior based on a result of the evaluation of the driving behavior.

According to an example embodiment of the present disclosure, a method for guiding driving behavior may be provided. The method may comprise obtaining a standard driving cycle of a vehicle and parameter values of driving characteristics of the standard driving cycle, obtaining parameter values of actual driving data with respect to the driving characteristics of the standard driving cycle during driving by a driver, evaluating driving behavior by comparing the parameter values of the driving characteristics of the standard driving cycle with the parameter values of the actual driving data with respect to the driving characteristics of the standard driving cycle, and guiding the driving behavior based on a result of the evaluation of the driving behavior.

The driving characteristics may include average speed, maximum speed, maximum acceleration, maximum deceleration, acceleration ratio, deceleration ratio, constant-speed ratio, and idling ratio.

The standard driving cycle may be classified according to different speed sections. Comparing the parameter values of the driving characteristics of the standard driving cycle with the parameter values of the actual driving data with respect to the driving characteristics of the standard driving cycle may include determining a speed section for comparison from among the speed sections of the standard driving cycle based on an average speed value of the actual driving data, and may include comparing the parameter values of the actual driving data with respect to the driving characteristics with the parameter values of the corresponding driving characteristics of the standard driving cycle in the determined speed section.

Evaluating driving behavior by comparing the parameter values of the driving characteristics of the standard driving cycle with the parameter values of the actual driving data with respect to the driving characteristics of the standard driving cycle may include determining at least one speed threshold between speed sections of the standard driving cycle based on average speed values in each speed section, and determining a speed range corresponding to each speed section segmented using the at least one speed threshold. Comparing the parameter values of the driving characteristics of the standard driving cycle with the parameter values of the actual driving data with respect to the driving characteristics of the standard driving cycle may also include comparing an average speed value of the actual driving data with the determined speed threshold, and determining a corresponding speed section based on a speed range in which the average speed value of the actual driving data is located. After determining the speed section, the method may include comparing a maximum speed value of the actual driving data with a maximum speed value of the standard driving cycle in the determined speed section, evaluating the driving behavior as high energy consumption driving behavior based on the maximum speed value of the actual driving data being greater than the maximum speed value of the standard driving cycle in the determined speed section by a first preset value or more, and evaluating the driving behavior as low energy consumption driving behavior based on the maximum speed value of the actual driving data being less than the maximum speed value of the standard driving cycle in the determined speed section by a second preset value or more.

Evaluating driving behavior by comparing the parameter values of the driving characteristics of the standard driving cycle with the parameter values of the actual driving data with respect to the driving characteristics of the standard driving cycle may further include, based on the maximum speed value of the actual driving data being close to the maximum speed value of the standard driving cycle in the determined speed section by less than or equal to a first threshold value, comparing a maximum acceleration value and a maximum deceleration value of the actual driving data with a maximum acceleration value and a maximum deceleration value of the standard driving cycle in the determined speed section, respectively. The method may also include evaluating the driving behavior as high energy consumption driving behavior based on the maximum acceleration value of the actual driving data being greater than the maximum acceleration value of the standard driving cycle in the determined speed section by a third preset value or more, and the maximum deceleration value of the actual driving data being greater than the maximum deceleration value of the standard driving cycle in the determined speed section by a fourth preset value or more. The method further may include evaluating the driving behavior as low energy consumption driving behavior based on the maximum acceleration value of the actual driving data being less than the maximum acceleration value of the standard driving cycle in the determined speed section by a fifth preset value or more, and the maximum deceleration value of the actual driving data being less than the maximum deceleration value of the standard driving cycle in the determined speed section by a sixth preset value or more.

Evaluating driving behavior by comparing the parameter values of the driving characteristics of the standard driving cycle with the parameter values of the actual driving data with respect to the driving characteristics of the standard driving cycle may further include, based on the maximum acceleration value of the actual driving data being greater than the maximum acceleration value of the standard driving cycle in the determined speed section by the third preset value or more, and the maximum deceleration value of the actual driving data being less than the maximum deceleration value of the standard driving cycle in the determined speed section by the sixth preset value or more, comparing an acceleration ratio value and a deceleration ratio value of the actual driving data with an acceleration ratio value and a deceleration ratio value of the standard driving cycle in the determined speed section, respectively. Further, the method may include, based on the maximum acceleration value of the actual driving data being less than the maximum acceleration value of the standard driving cycle in the determined speed section by the fifth preset value or more, and the maximum deceleration value of the actual driving data being greater than the maximum deceleration value of the standard driving cycle in the determined speed section by the fourth preset value or more, comparing the acceleration ratio value and the deceleration ratio value of the actual driving data with the acceleration ratio value and the deceleration ratio value of the standard driving cycle in the determined speed section, respectively. Also, the method may include, based on the maximum acceleration value of the actual driving data being close to the maximum acceleration value of the standard driving cycle in the determined speed section by less than or equal to a second threshold value, or based on the maximum deceleration value of the actual driving data being close to the maximum deceleration value of the standard driving cycle in the determined speed section by less than or equal to a third threshold value, comparing the acceleration ratio value and the deceleration ratio value of the actual driving data with the acceleration ratio value and the deceleration ratio value of the standard driving cycle in the determined speed section, respectively. Also, the method may include evaluating the driving behavior as high energy consumption driving behavior based on the acceleration ratio value of the actual driving data being greater than the acceleration ratio value of the standard driving cycle in the determined speed section, and the deceleration ratio value of the actual driving data being less than the deceleration ratio value of the standard driving cycle in the determined speed section, and evaluating the driving behavior as low energy consumption driving behavior based on the acceleration ratio value of the actual driving data being less than the acceleration ratio value of the standard driving cycle in the determined speed section, and the deceleration ratio value of the actual driving data being greater than the deceleration ratio value of the standard driving cycle in the determined speed section.

Guiding the driving behavior based on a result of the evaluation of the driving behavior may include, based on the driving behavior being evaluated as high energy consumption driving behavior, providing a notification to reduce the speed of the vehicle or gently operate accelerator and brake pedals, and based on the driving behavior being evaluated as low energy consumption driving behavior, providing a notification to increase the speed of the vehicle or drive with confidence.

The method for guiding driving behavior may further include providing a difference value between a driving range of the actual driving data and a driving range of the standard driving cycle, wherein the difference value is calculated using the following formula:

$${L}_{Δ} = \vert \frac{E \times S}{{\int }_{{t}_{1}}^{{t}_{2}} P} - {L}_{R} \vert$$

wherein L_{Δ} is the difference between the driving range of the actual driving data and the driving range of the standard driving cycle, expressed in kilometers (km),

$$\frac{E \times S}{{\int }_{{t}_{1}}^{{t}_{2}} P}$$

is the driving range of the actual driving data, expressed in kilometers (km), E is a battery capacity, expressed in kilowatt-hours (kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), and L_{R} is a driving range measured based on the standard driving cycle corresponding to a vehicle type, expressed in kilometers (km).

The method for guiding driving behavior may further include providing a difference value between a driving distance per unit energy of the actual driving data and a driving distance per unit energy of the standard driving cycle, wherein the difference value is calculated using the following formula:

$$M = \vert \frac{S}{{\int }_{{t}_{1}}^{{t}_{2}} P} - \frac{{L}_{R}}{E} \vert$$

wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type, expressed in kilometers (km).

Obtaining parameter values of actual driving data with respect to the driving characteristics of the standard driving cycle during driving by a driver may further include obtaining the parameter values of the actual driving data with respect to the driving characteristics of the standard driving cycle from outside the vehicle using over-the-air (OTA) technology.

According to another example embodiment of the present disclosure, an apparatus for guiding driving behavior may be provided. The apparatus may include at least one processor, and at least one memory configured to store instructions that, when executed by the at least one processor, cause the at least one processor to obtain a standard driving cycle of a vehicle and parameter values of driving characteristics of the standard driving cycle, obtain parameter values of actual driving data with respect to the driving characteristics of the standard driving cycle during driving by a driver, evaluate driving behavior by comparing the parameter values of the driving characteristics of the standard driving cycle with the parameter values of the actual driving data with respect to the driving characteristics of the standard driving cycle, and guide the driving behavior based on a result of the evaluation of the driving behavior.

The driving characteristics may include all or some of average speed, maximum speed, maximum acceleration, maximum deceleration, acceleration ratio, deceleration ratio, constant-speed ratio, and idling ratio.

The standard driving cycle may be classified according to different speed sections. The at least one processor may be configured to determine a speed section for comparison from among the speed sections of the standard driving cycle based on an average speed value of the actual driving data, and compare the parameter values of the actual driving data with respect to the driving characteristics with the parameter values of the corresponding driving characteristics of the standard driving cycle in the determined speed section.

The at least one processor may be configured to determine at least one speed threshold between speed sections of the standard driving cycle based on average speed values in each speed section, and determine a speed range corresponding to each speed section segmented using the at least one speed threshold. The processor may also be configured to compare an average speed value of the actual driving data with the determined speed threshold, and determine a corresponding speed section based on a speed range in which the average speed value of the actual driving data is located. After determining the speed section, the processor may be configured to compare a maximum speed value of the actual driving data with a maximum speed value of the standard driving cycle in the determined speed section. Further, the processor may be configured to evaluate the driving behavior as high energy consumption driving behavior based on the maximum speed value of the actual driving data being greater than the maximum speed value of the standard driving cycle in the determined speed section by a first preset value or more, and evaluate the driving behavior as low energy consumption driving behavior based on the maximum speed value of the actual driving data being less than the maximum speed value of the standard driving cycle in the determined speed section by a second preset value or more.

The at least one processor may be configured to, based on the maximum speed value of the actual driving data being close to the maximum speed value of the standard driving cycle in the determined speed section by less than or equal to a first threshold value, compare a maximum acceleration value and a maximum deceleration value of the actual driving data with a maximum acceleration value and a maximum deceleration value of the standard driving cycle in the determined speed section, respectively. The processor further may be configured to evaluate the driving behavior as high energy consumption driving behavior based on the maximum acceleration value of the actual driving data being greater than the maximum acceleration value of the standard driving cycle in the determined speed section by a third preset value or more, and the maximum deceleration value of the actual driving data being greater than the maximum deceleration value of the standard driving cycle in the determined speed section by a fourth preset value or more. Additionally, the processor may be configured to evaluate the driving behavior as low energy consumption driving behavior based on the maximum acceleration value of the actual driving data being less than the maximum acceleration value of the standard driving cycle in the determined speed section by a fifth preset value or more, and the maximum deceleration value of the actual driving data being less than the maximum deceleration value of the standard driving cycle in the determined speed section by a sixth preset value or more.

The at least one processor may be configured to, based on the maximum acceleration value of the actual driving data being greater than the maximum acceleration value of the standard driving cycle in the determined speed section by the third preset value or more, and the maximum deceleration value of the actual driving data being less than the maximum deceleration value of the standard driving cycle in the determined speed section by the sixth preset value or more, compare an acceleration ratio value and a deceleration ratio value of the actual driving data with an acceleration ratio value and a deceleration ratio value of the standard driving cycle in the determined speed section, respectively. The at least one processor may be configured to, based on the maximum acceleration value of the actual driving data being less than the maximum acceleration value of the standard driving cycle in the determined speed section by the fifth preset value or more, and the maximum deceleration value of the actual driving data being greater than the maximum deceleration value of the standard driving cycle in the determined speed section by the fourth preset value or more, compare the acceleration ratio value and the deceleration ratio value of the actual driving data with the acceleration ratio value and the deceleration ratio value of the standard driving cycle in the determined speed section, respectively. The at least one processor may be configured to, based on the maximum acceleration value of the actual driving data being close to the maximum acceleration value of the standard driving cycle in the determined speed section by less than or equal to a second threshold value, or based on the maximum deceleration value of the actual driving data being close to the maximum deceleration value of the standard driving cycle in the determined speed section by less than or equal to a third threshold value, compare the acceleration ratio value and the deceleration ratio value of the actual driving data with the acceleration ratio value and the deceleration ratio value of the standard driving cycle in the determined speed section, respectively. The processor further may be configured to evaluate the driving behavior as high energy consumption driving behavior based on the acceleration ratio value of the actual driving data being greater than the acceleration ratio value of the standard driving cycle in the determined speed section, and the deceleration ratio value of the actual driving data being less than the deceleration ratio value of the standard driving cycle in the determined speed section, and evaluate the driving behavior as low energy consumption driving behavior based on the acceleration ratio value of the actual driving data being less than the acceleration ratio value of the standard driving cycle in the determined speed section, and the deceleration ratio value of the actual driving data being greater than the deceleration ratio value of the standard driving cycle in the determined speed section.

The at least one processor may be configured to, based on the driving behavior being evaluated as high energy consumption driving behavior, provide a notification to reduce the speed of the vehicle or gently operate accelerator and brake pedals, and based on the driving behavior being evaluated as low energy consumption driving behavior, provide a notification to increase the speed of the vehicle or drive with confidence.

The at least one processor may be configured to provide a difference value between a driving range of the actual driving data and a driving range of the standard driving cycle, wherein the difference value is calculated using the following formula:

$${L}_{Δ} = \vert \frac{E \times S}{{\int }_{{t}_{1}}^{{t}_{2}} P} - {L}_{R} \vert$$

wherein L_{Δ} is the difference between the driving range of the actual driving data and the driving range of the standard driving cycle, expressed in kilometers (km),

$$\frac{E \times S}{{\int }_{{t}_{1}}^{{t}_{2}} P}$$

is the driving range of the actual driving data, expressed in kilometers (km), E is a battery capacity, expressed in kilowatt-hours (kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), and L_{R} is a driving range measured based on the standard driving cycle corresponding to a vehicle type, expressed in kilometers (km).

The at least one processor may be configured to provide a difference value between a driving distance per unit energy of the actual driving data and a driving distance per unit energy of the standard driving cycle, wherein the difference value is calculated using the following formula:

$$M = \vert \frac{S}{{\int }_{{t}_{1}}^{{t}_{2}} P} - \frac{{L}_{R}}{E} \vert$$

wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type, expressed in kilometers (km).

The at least one processor may be configured to obtain the parameter values of the actual driving data with respect to the driving characteristics of the standard driving cycle from outside the vehicle using over-the-air (OTA) technology.

According to embodiments of the present disclosure, the impact of a driver's driving behavior on the energy consumption of a vehicle as measured based on a standard driving cycle may be evaluated. Accordingly, a vehicle user may recognize a difference between the actual energy consumption of the vehicle and the energy consumption measured based on the standard driving cycle, and the driving behavior of the vehicle user may be guided accordingly.

### BRIEF DESCRIPTION OF THE DRAWINGS

The foregoing and other aspects, as well as the following detailed description of the embodiments, may be better understood when read in conjunction with the accompanying drawings. However, the present disclosure is not intended to be limited to the details shown in the drawings, and various modifications and structural changes may be made therein without departing from the present disclosure and within the scope and range of equivalents of the claims. Like reference numbers and designations in the various drawings indicate like elements.

FIG. 1 shows a speed-time curve of the China Light-duty Vehicle Test Cycle for Passenger Car (CLTC-P) driving cycle.

FIG. 2 illustrates an example automotive energy consumption label for a specific vehicle type.

FIG. 3 is a flowchart illustrating a method for guiding driving behavior according to an example embodiment of the present disclosure.

FIGS. 4A and 4B are flowcharts illustrating processes for comparing parameter values of driving characteristics of a standard driving cycle with parameter values of actual driving data with respect to the corresponding driving characteristics of the standard driving cycle, according to an example embodiment of the present disclosure.

### DETAILED DESCRIPTION

Hereinafter, some embodiments of the present disclosure will be described in more detail. However, the following embodiments are provided as references for describing the present disclosure in detail, and the present disclosure is not limited thereto and may be implemented in various forms.

Unless otherwise provided, technical and scientific terms used in the present disclosure may have the same meanings as commonly understood by those skilled in the art of this application. The terms “include,” “comprise,” and any variations thereof used in the specification of this application are intended to encompass non-exclusive inclusion.

The present disclosure may use ordinal numbers such as “first,” “second,” “third,” etc., to refer to elements, and, unless explicitly indicated otherwise, these ordinal numbers are used to distinguish between different elements and do not imply that the mentioned elements are provided in the indicated order in terms of time, space, or other aspects.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

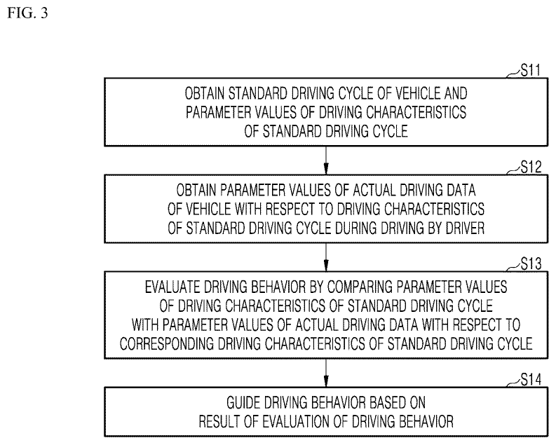

FIG. 3 is a flowchart of a method for guiding driving behavior according to an example embodiment of the present disclosure. As shown in FIG. 3, the method for guiding driving behavior according to this example embodiment of the present disclosure may include obtaining a standard driving cycle of a vehicle and parameter values of driving characteristics of the standard driving cycle (S11), obtaining parameter values of actual driving data with respect to the driving characteristics of the standard driving cycle during driving by a driver (S12), evaluating driving behavior by comparing the parameter values of the driving characteristics of the standard driving cycle with the parameter values of the actual driving data with respect to the corresponding driving characteristics of the standard driving cycle (S13), and guiding the driving behavior based on a result of the evaluation of the driving behavior (S14).

S11 to S14 are described in detail below.

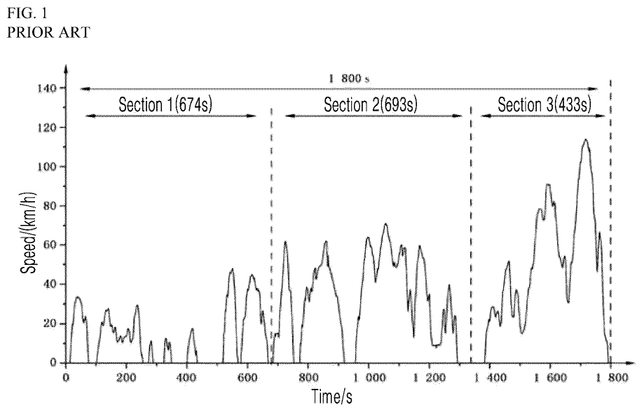

In S11, a standard driving cycle of the vehicle may be obtained. A vehicle driving cycle may display speed-time curves of the most representative vehicle driving characteristics for a particular type of vehicle on a particular section of road or in a particular area. For example, the standard driving cycle may include the New European Driving Cycle (NEDC), the World Light Vehicle Test Cycle (WLTC), the Multi-Cycle Test (MCT), the China Light-duty Vehicle Test Cycle (CLTC), or the like. For example, the China Light-duty Vehicle Test Cycle (CLTC) may include the China Light-duty Vehicle Test Cycle for Commercial Vehicle (CLTC-C) and the China Light-duty Vehicle Test Cycle for Passenger Car (CLTC-P). For example, FIG. 1 shows the speed-time curve of the China Light-duty Vehicle Test Cycle for Passenger Car (CLTC-P) driving cycle.

Since various standard vehicle driving cycles exist worldwide, in S11, it is useful to obtain the standard driving cycle of the vehicle. In an example embodiment, at least one (e.g., appropriate) standard driving cycle may be selected from among various standard driving cycles pre-installed on a remote data platform.

The (e.g., appropriate) standard driving cycle may be selected based on the vehicle's purpose and/or driving environment. For example, for light-duty vehicles purchased by Chinese families for family travel, the China Light-duty Vehicle Test Cycle (CLTC) may be selected, but the present disclosure is not limited thereto. For example, for a large number of commercial freight vehicles purchased by (e.g., large) companies for cargo transportation, a standard driving cycle including urban driving conditions, suburban driving conditions, and highway driving conditions may be selected, as some commercial freight vehicles travel on fixed routes and typically travel between cities, suburbs, and highways.

In other embodiments, the standard driving cycle may be pre-stored in the vehicle storage device and obtained from the vehicle storage device when requested (e.g., needed). For example, vehicles applied to the Chinese market may store (e.g., only) the China Light-duty Vehicle Test Cycle (CLTC), vehicles applied to the European market may store (e.g., only) the World Light Vehicle Test Cycle (WLTC), and vehicles applied to the US market may store (e.g., only) the Multi-Cycle Test (MCT). The present disclosure is not limited thereto, and various standard driving cycles may be pre-stored in the vehicle storage device, and at least one appropriate standard driving cycle may be selected from among the various standard driving cycles pre-stored in the vehicle storage device.

In S11, after obtaining the standard driving cycle, parameter values of driving characteristics of the standard driving cycle may be further obtained. For example, the driving characteristics may include all or some of average speed, maximum speed, maximum acceleration, maximum deceleration, acceleration ratio, deceleration ratio, constant-speed ratio, and idling ratio.

Taking the China Light-duty Vehicle Test Cycle for Passenger Car (CLTC-P) driving cycle as an example, Table 1 shows parameter values for the driving characteristics of the China Light-duty Vehicle Test Cycle for Passenger Car (CLTC-P) driving cycle, and these parameter values are described in the Chinese national standard GB/T 38146.1-2019 “China Automotive Test Cycle—Part 1: Light-duty Vehicles.”

TABLE 1

| | Low-Speed | Medium-Speed | High-Speed |
|---|---|---|---|
| | Section | Section | Section |
| Average Speed | 13.09 | 30.68 | 50.90 |
| (km/h) | | | |
| Maximum Speed | 48.10 | 71.20 | 114.00 |
| (km/h) | | | |
| Maximum | 1.47 | 1.44 | 1.06 |
| Acceleration (m/s²) | | | |
| Maximum | −1.42 | −1.47 | −1.46 |
| Deceleration (m/s²) | | | |
| Acceleration Ratio | 22.55 | 30.45 | 35.80 |
| (%) | | | |
| Deceleration Ratio | 21.51 | 28.43 | 30.95 |
| (%) | | | |
| Constant-Speed | 20.77 | 21.36 | 27.71 |
| Ratio (%) | | | |
| Idling Ratio (%) | 35.16 | 19.77 | 5.54 |

In S12, parameter values of actual driving data with respect to the driving characteristics of the standard driving cycle may be obtained during driving of the vehicle by the driver.

For example, when the driving characteristics of the standard driving cycle obtained in S11 include average speed, maximum speed, maximum acceleration, maximum deceleration, acceleration ratio, and deceleration ratio, in S12, correspondingly, the average speed value, maximum speed value, maximum acceleration value, maximum deceleration value, acceleration ratio value, and deceleration ratio value of the vehicle within a predetermined time interval (for example, from time t₁ to time t₂) may be obtained.

In an example embodiment, various sensors installed in the vehicle (for example, speed sensors, acceleration sensors, and the like) may detect the vehicle's speed values, acceleration values, deceleration values, and the like in real time. The vehicle may upload the detected various sensor data to a server (for example, a big data platform) using over-the-air (OTA) technology. The server may calculate the vehicle's average speed value, maximum speed value, maximum acceleration value, and the like within the predetermined time interval according to the received sensor data. The server may then transmit the calculated results to the vehicle using OTA technology, whereby the vehicle obtains the average speed value, maximum speed value, maximum acceleration value, and the like within the predetermined time interval from outside the vehicle using OTA technology. In other example embodiments, the calculation operation may be performed by a computing device of the vehicle.

Taking the China Light-duty Vehicle Test Cycle for Passenger Car (CLTC-P) driving cycle of FIG. 1 and Table 1 as an example, the China Light-duty Vehicle Test Cycle for Passenger Car (CLTC-P) driving cycle includes three speed sections: low speed (Section 1), medium speed (Section 2), and high speed (Section 3).

Other commonly used standard driving cycles may include similar speed section-related classifications. For example, the New European Driving Cycle (NEDC) is generally classified into two speed sections: low speed (urban) and high speed (suburban), where the average speed of the urban driving section is 19 km/h and the average speed of the suburban driving section is 62.6 km/h. The World Light Vehicle Test Cycle (WLTC) is classified into generally four speed sections: low speed, medium speed, high speed, and extra-high speed.

In example embodiments, the standard driving cycle is classified according to different speed sections, and accordingly, the parameter values of the driving characteristics of the standard driving cycle may include parameter values of the driving characteristics of the standard driving cycle in each speed section. For example, as shown in Table 1, for the driving characteristic of maximum acceleration, the maximum acceleration values include the maximum acceleration value in the low-speed section of 1.47 m/s², the maximum acceleration value in the medium-speed section of 1.44 m/s², and the maximum acceleration value in the high-speed section of 1.06 m/s².

Since the parameter values of the driving characteristics of the standard driving cycle include parameter values of the driving characteristics of the standard driving cycle in each speed section, in the process of comparing the parameter values of the driving characteristics of the standard driving cycle with the parameter values of the actual driving data with respect to the corresponding driving characteristics of the standard driving cycle in S13, a speed section must first be determined. Through this, the value (e.g., magnitude) of the parameter values of the actual driving data and the parameter values of the standard driving cycle in the determined speed section may be compared based on the same driving characteristics.

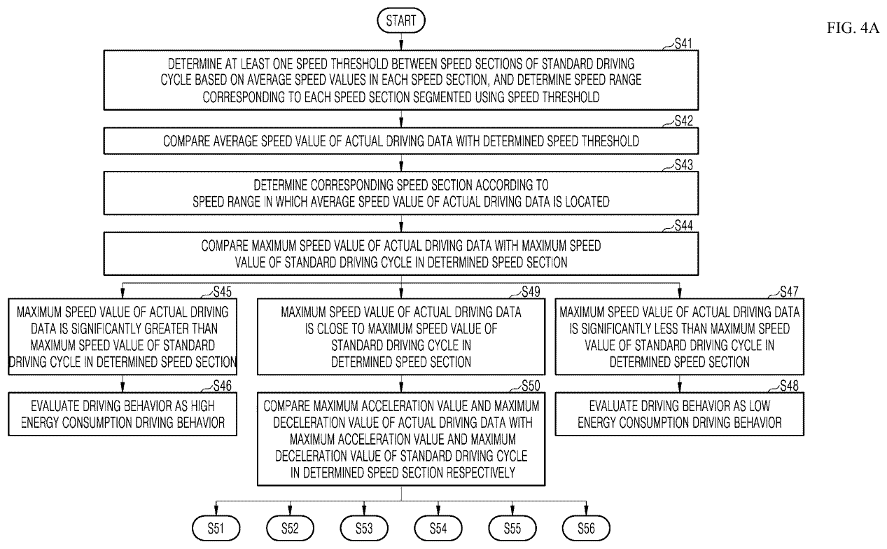

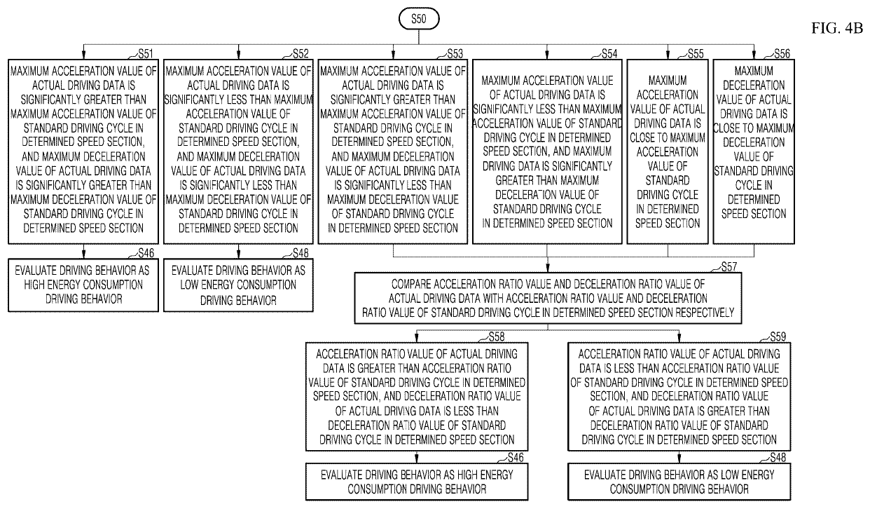

FIGS. 4A and 4B are flowcharts illustrating detailed processes for comparing parameter values of driving characteristics of a standard driving cycle with parameter values of actual driving data with respect to the corresponding driving characteristics of the standard driving cycle, according to an example embodiment of the present disclosure.

As described above, first, a speed section for comparison with the actual driving data may be determined from among the speed sections of the standard driving cycle, according to the average speed value of the actual driving data.

Taking the China Light-duty Vehicle Test Cycle for Passenger Car (CLTC-P) driving cycle as an example, as shown in Table 1, the average speed value of the low-speed section is 13.09 km/h, the average speed value of the medium-speed section is 30.68 km/h, and the average speed value of the high-speed section is 50.90 km/h. Based on the average speed values of 13.09 km/h, 30.68 km/h, and 50.90 km/h, speed threshold values—e.g., 20 km/h and 40 km/h—and speed ranges corresponding to each speed section segmented using the speed threshold values 20 km/h and 40 km/h, such as, a speed range of less than or equal to 20 km/h (corresponding to the low-speed section), a speed range of greater than 20 km/h and less than or equal to 40 km/h (corresponding to the medium-speed section), and a speed range of greater than 40 km/h (corresponding to the high-speed section), may be determined (S41). Accordingly, the average speed value of the actual driving data may be compared with the determined speed threshold (S42), and a corresponding speed section may be determined according to the speed range in which the average speed value of the actual driving data is located (S43). That is, based on the average speed value of the actual driving data being less than or equal to 20 km/h, the low-speed section may be determined from among the low-speed section, medium-speed section, and high-speed section. Based on the average speed value of the actual driving data being greater than 20 km/h and less than or equal to 40 km/h, the medium-speed section may be determined from among the low-speed section, medium-speed section, and high-speed section. Based on the average speed value of the actual driving data being greater than 40 km/h, the high-speed section may be determined from among the low-speed section, medium-speed section, and high-speed section.

In the above example, the determined speed thresholds are close to intermediate values between the average speed values of the standard driving cycle in two adjacent speed sections, that is, the speed threshold value of 20 km/h is approximately the intermediate value between the average speed values of 13.09 km/h and 30.68 km/h, and the speed threshold value of 40 km/h is approximately the intermediate value between the average speed values of 30.68 km/h and 50.90 km/h. However, the method for determining speed threshold values of the present disclosure is not limited thereto.

After the speed section is determined, the parameter values of the actual driving data with respect to the driving characteristics may be compared with the parameter values of the corresponding driving characteristics of the standard driving cycle in the determined speed section.

In an example embodiment, when the driving characteristics include average speed, maximum speed, maximum acceleration, maximum deceleration, acceleration ratio, and deceleration ratio, since the average speed value has (e.g., already) been used to determine the speed section for comparison in S41 and S42, priorities for comparison may be assigned to the driving characteristics excluding average speed in subsequent processes. For example, maximum speed may be assigned as the first priority driving characteristic, maximum acceleration and maximum deceleration may be assigned as the second priority driving characteristics, and acceleration ratio and deceleration ratio may be assigned as the third priority driving characteristics, but the present disclosure is not limited thereto. Accordingly, the parameter values of the actual driving data and the standard driving cycle for the same driving characteristics may be compared according to the assigned order of priority.

For example, the maximum speed value of the actual driving data may be compared with the maximum speed value of the standard driving cycle in the determined speed section (S44).

A maximum speed value of the actual driving data that is significantly greater than the maximum speed value of the standard driving cycle in the determined speed section (S45) indicates that the driver's driving behavior is causing the vehicle to drive at high speed, and the high-speed driving is causing high energy consumption. In other words, in this case, the driving behavior may be evaluated as high energy consumption driving behavior (S46).

Herein, “element A being significantly greater than element B” may indicate (e.g., mean) that the value obtained by subtracting element B from element A is greater than a preset value λ, or that the value obtained by subtracting element B from element A is greater than a preset ratio φ of element B.

For example, when the determined speed section is the low-speed section, as shown in Table 1, the maximum speed value of the standard driving cycle in the low-speed section is 48.10 km/h. In a first example, based on the maximum speed value of the actual driving data being greater than (48.10+λ1) km/h, the driving behavior may be evaluated as high energy consumption driving behavior. Here, λ1 is a preset value for comparing maximum speed values. For example, λ1 may be equal to 3 km/h, but is not limited thereto. In a second example, based on the maximum speed value of the actual driving data being greater than (48.10+48.10φ1) km/h, the driving behavior may be evaluated as high energy consumption driving behavior. Here, φ1 is a preset ratio for comparing maximum speed values. For example, 1 may be equal to 5%, but is not limited thereto.

A maximum speed value of the actual driving data that is significantly less than the maximum speed value of the standard driving cycle in the determined speed section (S47) indicates that the driver's driving behavior is causing the vehicle to drive slowly, and slow vehicle driving is favorable for low energy consumption. In other words, in this case, the driving behavior may be evaluated as low energy consumption driving behavior (S48).

Herein, “element A being significantly less than element B” may indicate (e.g., mean) that the value obtained by subtracting element A from element B is greater than a preset value λ, or that the value obtained by subtracting element A from element B is greater than a preset ratio q of element B.

In the aforementioned first example, based on the maximum speed value of the actual driving data being less than (48.10−λ1) km/h, the driving behavior may be evaluated as low energy consumption driving behavior. In the aforementioned second example, based on the maximum speed value of the actual driving data being less than (48.10−48.10φ1) km/h, the driving behavior may be evaluated as low energy consumption driving behavior.

Moreover, if the maximum speed value of the actual driving data is close to the maximum speed value of the standard driving cycle in the determined speed section (S49), this may be insufficient to obtain an evaluation result of the driving behavior.

Herein, “element A being close to element B” may indicate (e.g., mean) that the absolute value of the difference between element A and element B is less than or equal to a preset value λ, or that the absolute value of the difference between element A and element B is less than or equal to a preset ratio q of element B.

In the aforementioned first example, if the maximum speed value of the actual driving data is greater than or equal to (48.10−λ1) km/h and less than or equal to (48.10+λ1) km/h, this may be insufficient to obtain an evaluation result of the driving behavior. In the aforementioned second example, if the maximum speed value of the actual driving data is greater than or equal to (48.10−48.10φ1) km/h and less than or equal to (48.10+48.10φ1) km/h, this may be insufficient to obtain an evaluation result of the driving behavior.

When such conditions are insufficient to obtain an evaluation result of the driving behavior, the second priority driving characteristics must be further compared. For example, the maximum acceleration value and maximum deceleration value of the actual driving data may be respectively compared with the maximum acceleration value and maximum deceleration value of the standard driving cycle in the determined speed section (S50).

Maximum acceleration refers to the greatest acceleration reached during acceleration behavior in the vehicle driving process, and a large maximum acceleration means that the driver has rapid acceleration driving behavior during the driving process, which increases vehicle energy consumption. Maximum deceleration refers to the greatest deceleration reached during deceleration behavior in the vehicle driving process. Herein, considering the direction of deceleration, the maximum deceleration value is provided (e.g., defined) as a negative number. The larger the absolute value of the maximum deceleration, the faster the driver decelerates during driving, and accordingly, more energy is recovered through braking. In other words, a smaller maximum deceleration value is useful for reducing vehicle energy consumption.

Based on maximum acceleration value of the actual driving data being significantly greater than the maximum acceleration value of the standard driving cycle in the determined speed section and the maximum deceleration value of the actual driving data being significantly greater than the maximum deceleration value of the standard driving cycle in the determined speed section (S51), the driving behavior may be evaluated as high energy consumption driving behavior (S46).

Conversely, based on the maximum acceleration value of the actual driving data being significantly less than the maximum acceleration value of the standard driving cycle in the determined speed section and the maximum deceleration value of the actual driving data being significantly less than the maximum deceleration value of the standard driving cycle in the determined speed section (S52), the driving behavior may be evaluated as low energy consumption driving behavior (S48).

However, if the maximum acceleration value of the actual driving data is significantly greater than the maximum acceleration value of the standard driving cycle in the determined speed section and the maximum deceleration value of the actual driving data is significantly less than the maximum deceleration value of the standard driving cycle in the determined speed section (S53), or if the maximum acceleration value of the actual driving data is significantly less than the maximum acceleration value of the standard driving cycle in the determined speed section and the maximum deceleration value of the actual driving data is significantly greater than the maximum deceleration value of the standard driving cycle in the determined speed section (S54), since the maximum acceleration value and maximum deceleration value represent opposing inferences regarding energy consumption, this may be insufficient to obtain an evaluation result of the driving behavior, and the third priority driving characteristics must be further compared.

Moreover, if the maximum acceleration value of the actual driving data is close to the maximum acceleration value of the standard driving cycle in the determined speed section (S55), or if the maximum deceleration value of the actual driving data is close to the maximum deceleration value of the standard driving cycle in the determined speed section (S56), this may be insufficient to obtain an evaluation result of the driving behavior, and the third priority driving characteristics must be further compared.

For example, when the determined speed section is the low-speed section, as shown in Table 1, the maximum acceleration value of the standard driving cycle in the low-speed section is 1.47 m/s² and the maximum deceleration value is-1.42 m/s². Herein, considering the direction of deceleration, the maximum deceleration value of the actual driving data is also provided (e.g., defined) as a negative number.

Based on the maximum acceleration value of the actual driving data being greater than (1.47+λ₂) m/s² and the maximum deceleration value being greater than (−1.42+λ₃) m/s², the driving behavior may be evaluated as high energy consumption driving behavior.

Based on the maximum acceleration value of the actual driving data being less than (1.47−λ₂) m/s² and the maximum deceleration value being less than (−1.42−λ₃) m/s², the driving behavior may be evaluated as low energy consumption driving behavior.

If the maximum acceleration value of the actual driving data is less than (1.47−λ2) m/s² and the maximum deceleration value is greater than (−1.42+λ₃) m/s², or the maximum acceleration value of the actual driving data is greater than (1.47+λ₂) m/s² and the maximum deceleration value is less than (−1.42−λ₃) m/s², this may be insufficient to obtain an evaluation result of the driving behavior, and the third priority driving characteristics must be further compared.

Moreover, if the maximum acceleration value of the actual driving data is greater than or equal to (1.47−λ₂) m/s² and less than or equal to (1.47+λ₂) m/s², or the maximum deceleration value is greater than or equal to (−1.42−λ₃) m/s² and less than or equal to (−1.42+λ₃) m/s², this may be insufficient to obtain an evaluation result of the driving behavior, and the third priority driving characteristics must be further compared.

Here, λ₂ is a preset value for comparing maximum acceleration values, and λ₃ is a preset value for comparing maximum deceleration values. Both λ₂ and λ₃ are positive numbers, for example, λ₂ and λ₃ may be 0.5 m/s², but are not limited thereto.

When these conditions are insufficient to obtain an evaluation result of the driving behavior, to further compare the third priority driving characteristics, the acceleration ratio value and deceleration ratio value of the actual driving data may be respectively compared with the acceleration ratio value and deceleration ratio value of the standard driving cycle in the determined speed section (S57).

Acceleration ratio refers to the ratio of acceleration time to total time during the vehicle driving process, and deceleration ratio refers to the ratio of deceleration time to total time during the vehicle driving process. A high acceleration ratio indicates that the driver's driving behavior frequently accelerates the vehicle, which increases the vehicle's energy consumption. When the vehicle frequently decelerates, more energy is recovered through braking, so a high deceleration ratio is favorable for reducing the vehicle's energy consumption.

In other words, based on the acceleration ratio value of the actual driving data being greater than the acceleration ratio value of the standard driving cycle in the determined speed section and the deceleration ratio value of the actual driving data being less than the deceleration ratio value of the standard driving cycle in the determined speed section (S58), the driving behavior may be evaluated as high energy consumption driving behavior (S46).

Based on the acceleration ratio value of the actual driving data being less than the acceleration ratio value of the standard driving cycle in the determined speed section and the deceleration ratio value of the actual driving data being greater than the deceleration ratio value of the standard driving cycle in the determined speed section (S59), the driving behavior may be evaluated as low energy consumption driving behavior (S48).

For example, when the determined speed section is the low-speed section, as shown in Table 1, the acceleration ratio of the standard driving cycle in the low-speed section is 22.55% and the deceleration ratio is 21.51%.

Based on the acceleration ratio value of the actual driving data being greater than 22.55% and the deceleration ratio value of the actual driving data being less than 21.51%, the driving behavior may be evaluated as high energy consumption driving behavior. Based on the acceleration ratio value of the actual driving data being less than 22.55% and the deceleration ratio value of the actual driving data being greater than 21.51%, the driving behavior may be evaluated as low energy consumption driving behavior.

Therefore, through the comparison of the three-stage priority driving characteristics described above, the result of driving behavior evaluation, that is, whether the driving behavior is low energy consumption driving behavior or high energy consumption driving behavior, may be obtained.

If an evaluation result of the driving behavior still cannot be obtained after comparison of the third priority driving characteristics, a fourth priority driving characteristic may be further set for comparison, or the actual energy consumption of the vehicle may be directly determined to be the same as the vehicle energy consumption measured based on the standard driving cycle.

In the above example embodiment, the driver's driving behavior is evaluated through classification into low energy consumption driving behavior and high energy consumption driving behavior, but the present disclosure is not limited thereto. In other example embodiments, the driver's driving behavior may be evaluated through classification into aggressive driving behavior, conservative driving behavior, and stable driving behavior. For example, based on the maximum speed value of the actual driving data being significantly greater than the maximum speed value of the standard driving cycle in the determined speed section (S45), the driving behavior may be evaluated as aggressive driving behavior. Based on the maximum speed value of the actual driving data being significantly less than the maximum speed value of the standard driving cycle in the determined speed section (S47), the driving behavior may be evaluated as conservative driving behavior. Based on the maximum speed value of the actual driving data being close to the maximum speed value of the standard driving cycle in the determined speed section (S49), the driving behavior may be evaluated as stable driving behavior.

In S14, driving behavior may be guided based on a result of the evaluation of the driving behavior. Specifically, based on the driving behavior being evaluated as high energy consumption driving behavior, a notification may be provided to reduce the speed of the vehicle or gently operate the accelerator and brake pedals. Based on the driving behavior being evaluated as low energy consumption driving behavior, a notification may be provided to increase the speed of the vehicle or drive with confidence.

For example, the vehicle display may show messages such as “Current energy consumption is higher than certified energy consumption. Operate the accelerator pedal and brake pedal gently to reduce energy consumption” or “Current energy consumption is lower than certified energy consumption. Drive with confidence and enjoy a comfortable journey,” but the notifications of the present disclosure are not limited to text displayed on the display, and may also be voice output from vehicle speakers.

Furthermore, according to an example embodiment of the present disclosure, the method for guiding driving behavior may further include providing a difference value between a driving range of the actual driving data and a driving range of the standard driving cycle. The driving range refers to a continuous driving distance of an electric vehicle under certain road conditions when the battery is fully charged, and may also be referred to as the all-electric range (AER).

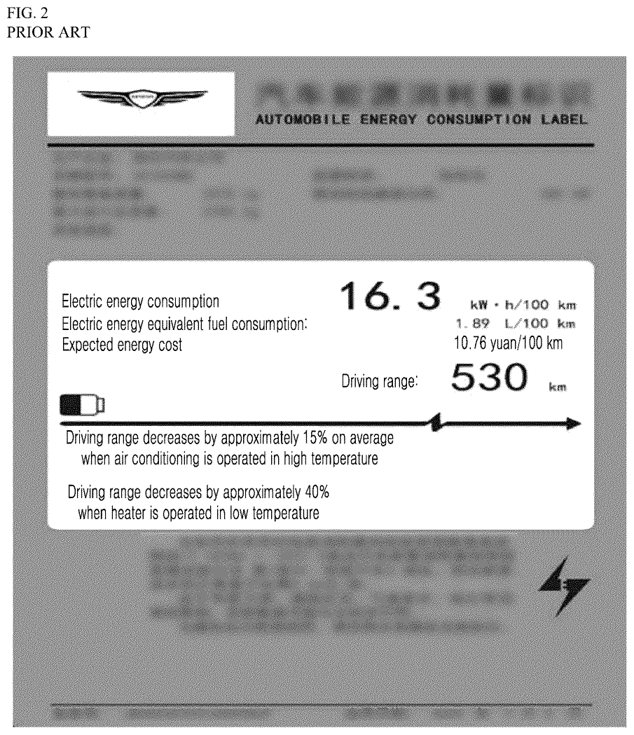

Regarding the driving range of the standard driving cycle, taking FIG. 2 as an example, for the vehicle type shown in FIG. 2, the driving range measured based on the China Light-duty Vehicle Test Cycle (CLTC) (which may be denoted by the symbol L_{R}) is 530 km.

The driving range of the actual driving data may be calculated using the following formula:

$${L}_{S} = \frac{E \times S}{{\int }_{{t}_{1}}^{{t}_{2}} P}$$

wherein Lₛ is the driving range of the actual driving data, expressed in kilometers (km), E is the battery capacity, expressed in kilowatt-hours (kWh), P is the battery output energy of the vehicle during driving by the driver from time t₁ to time t₂, with

$${\int }_{{t}_{1}}^{{t}_{2}} P$$

expressed in kilowatt-hours (kWh), and S is the driving distance of the vehicle from time t₁ to time t₂, expressed in kilometers (km).

Furthermore, the battery output energy (P) may be calculated according to the product of battery output current and battery output voltage, that is, P=UI, wherein P is the battery output energy, U is the battery output voltage, and I is the battery output current.

Accordingly, after obtaining the driving range of the actual driving data (Lₛ) and the driving range of the standard driving cycle (L_{R}), the difference value between them may be calculated as follows:

L_{Δ}=|L_{S}−L_{R}|,

wherein when Lₛ−L_{R}>0, for example, when Ls−LR=2 km, this indicates that the driving range of the actual driving data is greater than the driving range of the standard driving cycle. Accordingly, the notification provided by the method of the present disclosure may include “Current energy consumption is lower than certified energy consumption” as well as “AER: 2 km more driving.”

Conversely, when Lₛ−L_{R}<0, for example, when Lₛ−L_{R}=−2 km, this indicates that the driving range of the actual driving data is less than the driving range of the standard driving cycle. Accordingly, the notification provided by the method of the present disclosure may include “Current energy consumption is higher than certified energy consumption,” as well as “AER: 2 km less driving.”

According to an example embodiment of the present disclosure, as an alternative example embodiment to providing the difference value between the driving range of the actual driving data and the driving range of the standard driving cycle, the method for guiding driving behavior may include providing a difference value between the driving distance per unit energy of the actual driving data and the driving distance per unit energy of the standard driving cycle.

For example, the difference value between the driving distance per unit energy of the actual driving data and the driving distance per unit energy of the standard driving cycle may be calculated using the following formula:

$$M = \vert \frac{S}{{\int }_{{t}_{1}}^{{t}_{2}} P} - \frac{{L}_{R}}{E} \vert$$

wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type.

When

$$\frac{S}{{\int }_{{t}_{1}}^{{t}_{2}} P} - \frac{{L}_{R}}{E} > 0 ,$$

for example, when

$$\frac{S}{{\int }_{{t}_{1}}^{{t}_{2}} P} - \frac{{L}_{R}}{E} = 2$$

km, this indicates that the driving distance per unit energy of the actual driving data is greater than the driving distance per unit energy of the standard driving cycle. Accordingly, the notification provided by the method of the present disclosure may include “Current energy consumption is lower than certified energy consumption” as well as “2 km more driving per 1 kWh consumption.”

Conversely, when

$$\frac{S}{\text{?} P} - \frac{{L}_{R}}{E} < 0 ,$$

$$\text{?} \text{indicates text missing or illegible when filed}$$

for example, when

$$\frac{S}{\text{?} P} - \frac{{L}_{R}}{E} = - 2 km ,$$

$$\text{?} \text{indicates text missing or illegible when filed}$$

this indicates that the driving distance per unit energy of the actual driving data is less than the driving distance per unit energy of the standard driving cycle. Accordingly, the notification provided by the method of the present disclosure may include “Current energy consumption is higher than certified energy consumption,” as well as “2 km less driving per 1 kWh consumption.”

According to another example embodiment of the present disclosure, an apparatus for guiding driving behavior may be provided, comprising at least one processor, and at least one memory, wherein the at least one memory is configured to store instructions that, when accessed and executed by the at least one processor, cause the at least one processor to obtain a standard driving cycle of a vehicle and parameter values of driving characteristics of the standard driving cycle, obtain parameter values of actual driving data with respect to the driving characteristics of the standard driving cycle during driving by a driver, evaluate the driving behavior by comparing the parameter values of the driving characteristics of the standard driving cycle with the parameter values of the actual driving data with respect to the corresponding driving characteristics of the standard driving cycle, and guide the driving behavior based on a result of the evaluation.

The processor may be configured to obtain parameter values of the actual driving data with respect to the driving characteristics of the standard driving cycle from outside the vehicle using over-the-air (OTA) technology.

The driving characteristics may include all or some of average speed, maximum speed, maximum acceleration, maximum deceleration, acceleration ratio, deceleration ratio, constant-speed ratio, and idling ratio.

The standard driving cycle may be classified according to different speed sections. For example, the processor may be configured to determine a speed section for comparison from among the speed sections of the standard driving cycle based on an average speed value of the actual driving data, and compare the parameter values of the actual driving data with respect to the driving characteristics with the parameter values of the corresponding driving characteristics of the standard driving cycle in the determined speed section.

To determine the speed section for comparison with the actual driving data, the processor may be configured to determine at least one speed threshold between speed sections based on average speed values of the standard driving cycle in each speed section and determine speed ranges corresponding to each speed section segmented using the at least one speed threshold, compare the average speed value of the actual driving data with the determined speed threshold, and determine the corresponding speed section based on a speed range in which the average speed value of the actual driving data is located.

After determining the speed section, the processor may compare the maximum speed value of the actual driving data with the maximum speed value of the standard driving cycle in the determined speed section.

Based on the maximum speed value of the actual driving data being significantly greater than the maximum speed value of the standard driving cycle in the determined speed section, the processor may evaluate the driving behavior as high energy consumption driving behavior.

Based on the maximum speed value of the actual driving data being significantly less than the maximum speed value of the standard driving cycle in the determined speed section, the processor may evaluate the driving behavior as low energy consumption driving behavior.

If the maximum speed value of the actual driving data is close to the maximum speed value of the standard driving cycle in the determined speed section, this may be insufficient to obtain an evaluation result of the driving behavior, and the processor may compare the maximum acceleration value and maximum deceleration value of the actual driving data with the maximum acceleration value and maximum deceleration value of the standard driving cycle in the determined speed section, respectively.

Based on the maximum acceleration value of the actual driving data being significantly greater than the maximum acceleration value of the standard driving cycle in the determined speed section and the maximum deceleration value of the actual driving data being significantly greater than the maximum deceleration value of the standard driving cycle in the determined speed section, the processor may evaluate the driving behavior as high energy consumption driving behavior.

Based on the maximum acceleration value of the actual driving data being significantly less than the maximum acceleration value of the standard driving cycle in the determined speed section and the maximum deceleration value of the actual driving data being significantly less than the maximum deceleration value of the standard driving cycle in the determined speed section, the processor may evaluate the driving behavior as low energy consumption driving behavior.

Based on the maximum acceleration value of the actual driving data being significantly greater than the maximum acceleration value of the standard driving cycle in the determined speed section and the maximum deceleration value of the actual driving data being significantly less than the maximum deceleration value of the standard driving cycle in the determined speed section, the processor may compare the acceleration ratio value and deceleration ratio value of the actual driving data with the acceleration ratio value and deceleration ratio value of the standard driving cycle in the determined speed section, respectively.

Based on the maximum acceleration value of the actual driving data being significantly less than the maximum acceleration value of the standard driving cycle in the determined speed section and the maximum deceleration value of the actual driving data being significantly greater than the maximum deceleration value of the standard driving cycle in the determined speed section, the processor may compare the acceleration ratio value and deceleration ratio value of the actual driving data with the acceleration ratio value and deceleration ratio value of the standard driving cycle in the determined speed section, respectively.

Moreover, based on the maximum acceleration value of the actual driving data being close to the maximum acceleration value of the standard driving cycle in the determined speed section, or based on the maximum deceleration value of the actual driving data being close to the maximum deceleration value of the standard driving cycle in the determined speed section, the processor may compare the acceleration ratio value and deceleration ratio value of the actual driving data with the acceleration ratio value and deceleration ratio value of the standard driving cycle in the determined speed section, respectively.

Based on the acceleration ratio value of the actual driving data being greater than the acceleration ratio value of the standard driving cycle in the determined speed section and the deceleration ratio value of the actual driving data being less than the deceleration ratio value of the standard driving cycle in the determined speed section, the processor may evaluate the driving behavior as high energy consumption driving behavior.

Based on the acceleration ratio value of the actual driving data being less than the acceleration ratio value of the standard driving cycle in the determined speed section and the deceleration ratio value of the actual driving data being greater than the deceleration ratio value of the standard driving cycle in the determined speed section, the processor may evaluate the driving behavior as low energy consumption driving behavior.

Based on the driving behavior being evaluated as high energy consumption driving behavior, the processor may provide a notification to reduce the speed of the vehicle or gently operate the accelerator and brake pedals, and conversely, based on the driving behavior being evaluated as low energy consumption driving behavior, the processor may provide a notification to increase the speed of the vehicle or drive with confidence.

Moreover, the processor may be configured to provide a difference value between a driving range of the actual driving data and a driving range of the standard driving cycle, wherein the difference value is calculated using the following formula:

$${L}_{Δ} = \vert \frac{E \times S}{{\int }_{{t}_{1}}^{{t}_{2}} P} - {L}_{R} \vert$$

wherein L_{Δ} is the difference between the driving range of the actual driving data and the driving range of the standard driving cycle, expressed in kilometers (km),

$$\frac{E \times S}{{\int }_{{t}_{1}}^{{t}_{2}} P}$$

is the driving range of the actual driving data, expressed in kilometers (km), E is a battery capacity, expressed in kilowatt-hours (kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), and L_{R} is a driving range measured based on the standard driving cycle corresponding to a vehicle type, expressed in kilometers (km).

In an alternative example embodiment, the processor may be configured to provide a difference value between a distance per unit energy of the actual driving data and a distance per unit energy of the standard driving cycle, wherein the difference value is calculated using the following formula:

$$M = \vert \frac{S}{{\int }_{{t}_{1}}^{{t}_{2}} P} - \frac{{L}_{R}}{E} \vert$$

wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and

$${\int }_{{t}_{1}}^{{t}_{2}} P$$

is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type, expressed in kilometers (km).

The method and apparatus for guiding driving behavior according to embodiments of the present disclosure may evaluate the influence of a driver's driving behavior on vehicle energy consumption measured based on a standard driving cycle. As a result, vehicle users may understand the difference between the vehicle's actual energy consumption and the vehicle energy consumption measured based on the standard driving cycle, and the driver's driving behavior may be guided (e.g., through guidance) such as gently operating the accelerator and brake pedals and driving moderately.

The various embodiments of the present disclosure do not enumerate all possible combinations but are intended to describe representative aspects of the present disclosure, and moreover, the content described through various embodiments may be applied independently or in combination.

The present disclosure described as above is not limited by the aspects described herein and accompanying drawings. It should be apparent to those skilled in the art that various substitutions, changes and modifications which are not exemplified herein but are still within the scope of the present disclosure may be made. Therefore, the scope of the present disclosure is provided (e.g., defined) by the detailed description and the claims and their equivalents, and (e.g., all) variations within the scope of the claims and their equivalents are to be construed as included in the present disclosure.

What is claimed is:

1. A method for guiding driving behavior, comprising:
obtaining a standard driving cycle of a vehicle and parameter values of driving characteristics of the standard driving cycle;
obtaining parameter values of actual driving data for the driving characteristics of the standard driving cycle during driving of the vehicle by a driver;
evaluating driving behavior by comparing the parameter values of the driving characteristics of the standard driving cycle with the parameter values of the actual driving data for the driving characteristics of the standard driving cycle; and
guiding the driving behavior based on the evaluation of the driving behavior.

2. The method of claim 1, wherein the driving characteristics comprise at least one of average speed, maximum speed, maximum acceleration, maximum deceleration, acceleration ratio, deceleration ratio, constant-speed ratio, or idling ratio.

3. The method of claim 2,
wherein the standard driving cycle is classified into a plurality of speed sections, and
wherein evaluating driving behavior by comparing the parameter values of the driving characteristics of the standard driving cycle with the parameter values of the actual driving data with respect to the driving characteristics of the standard driving cycle comprises:
determining a speed section for comparison from among the speed sections of the standard driving cycle based on an average speed value of the actual driving data; and
comparing the parameter values of the actual driving data with respect to the driving characteristics with the parameter values of the corresponding driving characteristics of the standard driving cycle in the determined speed section.

4. The method of claim 2, wherein evaluating driving behavior by comparing the parameter values of the driving characteristics of the standard driving cycle with the parameter values of the actual driving data with respect to the driving characteristics of the standard driving cycle comprises:
determining at least one speed threshold between speed sections of the standard driving cycle based on average speed values in each speed section, and determining a speed range corresponding to each speed section segmented using the at least one speed threshold;
comparing an average speed value of the actual driving data with the determined speed threshold;
determining a corresponding speed section based on a speed range in which the average speed value of the actual driving data is located;
after determining the corresponding speed section, comparing a maximum speed value of the actual driving data with a maximum speed value of the standard driving cycle in the determined speed section;
evaluating the driving behavior as high energy consumption driving behavior based on the maximum speed value of the actual driving data being greater than the maximum speed value of the standard driving cycle in the determined speed section by a first preset value; and
evaluating the driving behavior as low energy consumption driving behavior based on the maximum speed value of the actual driving data being less than the maximum speed value of the standard driving cycle in the determined speed section by a second preset value.

5. The method of claim 4, wherein evaluating driving behavior by comparing the parameter values of the driving characteristics of the standard driving cycle with the parameter values of the actual driving data with respect to the driving characteristics of the standard driving cycle further comprises:
based on the maximum speed value of the actual driving data which has a difference less than or equal to a first threshold value in comparison with the maximum speed value of the standard driving cycle in the determined speed section, comparing a maximum acceleration value of the actual driving data with a maximum acceleration value of the standard driving cycle in the determined speed section and comparing a maximum deceleration value of the actual driving data with a maximum deceleration value of the standard driving cycle in the determined speed section;
evaluating the driving behavior as high energy consumption driving behavior based on the maximum acceleration value of the actual driving data being greater than the maximum acceleration value of the standard driving cycle in the determined speed section by a third preset value, and the maximum deceleration value of the actual driving data being greater than the maximum deceleration value of the standard driving cycle in the determined speed section by a fourth preset value; and
evaluating the driving behavior as low energy consumption driving behavior based on the maximum acceleration value of the actual driving data being less than the maximum acceleration value of the standard driving cycle in the determined speed section by a fifth preset value, and the maximum deceleration value of the actual driving data being less than the maximum deceleration value of the standard driving cycle in the determined speed section by a sixth preset value.

6. The method of claim 5, wherein evaluating driving behavior by comparing the parameter values of the driving characteristics of the standard driving cycle with the parameter values of the actual driving data with respect to the driving characteristics of the standard driving cycle further comprises:
based on the maximum acceleration value of the actual driving data being greater than the maximum acceleration value of the standard driving cycle in the determined speed section by the third preset value, and the maximum deceleration value of the actual driving data being less than the maximum deceleration value of the standard driving cycle in the determined speed section by the sixth preset value, comparing an acceleration ratio value of the actual driving data with an acceleration ratio value of the standard driving cycle in the determined speed section and comparing a deceleration ratio value of the actual driving data with a deceleration ratio value of the standard driving cycle in the determined speed section;
based on the maximum acceleration value of the actual driving data being less than the maximum acceleration value of the standard driving cycle in the determined speed section by the fifth preset value, and the maximum deceleration value of the actual driving data being greater than the maximum deceleration value of the standard driving cycle in the determined speed section by the fourth preset value, comparing the acceleration ratio value of the actual driving data with the acceleration ratio value of the standard driving cycle in the determined speed section and comparing the deceleration ratio value of the actual driving data with the deceleration ratio value of the standard driving cycle in the determined speed section;
based on the maximum acceleration value of the actual driving data which has a difference less than or equal to a second threshold value in comparison with the maximum acceleration value of the standard driving cycle in the determined speed section, or based on the maximum deceleration value of the actual driving data which has a difference less than or equal to a third threshold value in comparison with the maximum deceleration value of the standard driving cycle in the determined speed section, comparing the acceleration ratio value of the actual driving data with the acceleration ratio value of the standard driving cycle in the determined speed section and comparing the deceleration ratio value of the actual driving data with the deceleration ratio value of the standard driving cycle in the determined speed section;
evaluating the driving behavior as high energy consumption driving behavior based on the acceleration ratio value of the actual driving data being greater than the acceleration ratio value of the standard driving cycle in the determined speed section, and the deceleration ratio value of the actual driving data being less than the deceleration ratio value of the standard driving cycle in the determined speed section; and
evaluating the driving behavior as low energy consumption driving behavior based on the acceleration ratio value of the actual driving data being less than the acceleration ratio value of the standard driving cycle in the determined speed section, and the deceleration ratio value of the actual driving data being greater than the deceleration ratio value of the standard driving cycle in the determined speed section.

7. The method of claim 6, wherein the guiding the driving behavior based on a result of the evaluation of the driving behavior comprises:
based on the driving behavior being evaluated as high energy consumption driving behavior, providing a notification to reduce the speed of the vehicle; and
based on the driving behavior being evaluated as low energy consumption driving behavior, providing a notification to increase the speed of the vehicle.

8. The method of claim 1, further comprising providing a difference value between a driving range of the actual driving data and a driving range of the standard driving cycle, wherein the difference value is calculated using:
$${L}_{Δ} = \vert \frac{E \times S}{{\int }_{{t}_{1}}^{{t}_{2}} P} - {L}_{R} \vert$$
wherein L_{Δ} is the difference between the driving range of the actual driving data and the driving range of the standard driving cycle, expressed in kilometers (km),
$$\frac{E \times S}{{\int }_{{t}_{1}}^{{t}_{2}} P}$$
is the driving range of the actual driving data, expressed in kilometers (km), E is a battery capacity, expressed in kilowatt-hours (kWh), P is a battery output energy of the vehicle during driving by the driver from time t₁ to time t₂, and
$${\int }_{{t}_{1}}^{{t}_{2}} P$$
is expressed in kilowatt-hours (kWh), S is a driving distance of the vehicle from time t₁ to time t₂, expressed in kilometers (km), and L_{R} is a driving range measured based on the standard driving cycle corresponding to a vehicle type, expressed in kilometers (km).

9. The method of claim 1, further comprising providing a difference value between a driving distance per unit energy of the actual driving data and a driving distance per unit energy of the standard driving cycle, wherein the difference value is calculated using:
$$M = \vert \frac{S}{{\int }_{{t}_{1}}^{{t}_{2}} P} - \frac{{L}_{R}}{E} \vert$$
wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and
$${\int }_{{t}_{1}}^{{t}_{2}} P$$
is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type, expressed in kilometers (km).

10. The method of claim 1, wherein obtaining parameter values of actual driving data with respect to the driving characteristics of the standard driving cycle during driving by a driver comprises obtaining the parameter values of the actual driving data with respect to the driving characteristics of the standard driving cycle using over-the-air (OTA) technology.

11. An apparatus for guiding driving behavior, comprising:
at least one memory configured to store computer-executable instructions; and
at least one processor configured to access the memory and execute the instructions, wherein the instructions comprise:
obtaining a standard driving cycle of a vehicle and parameter values of driving characteristics of the standard driving cycle;
obtaining parameter values of actual driving data with respect to the driving characteristics of the standard driving cycle during driving by a driver;
evaluating driving behavior by comparing the parameter values of the driving characteristics of the standard driving cycle with the parameter values of the actual driving data with respect to the driving characteristics of the standard driving cycle; and
guiding the driving behavior based on a result of the evaluation of the driving behavior.

12. The apparatus of claim 11, wherein the driving characteristics comprise at least one of average speed, maximum speed, maximum acceleration, maximum deceleration, acceleration ratio, deceleration ratio, constant-speed ratio, or idling ratio.

13. The apparatus of claim 12,
wherein the standard driving cycle is classified into a plurality of speed sections, and
wherein the instructions of the at least one processor further comprise:
determining a speed section from the plurality of speed sections for comparison of the standard driving cycle based on an average speed value of the actual driving data; and
comparing the parameter values of the actual driving data of the driving characteristics with the parameter values of the corresponding driving characteristics of the standard driving cycle in the determined speed section.

14. The apparatus of claim 12, wherein the instructions of the at least one processor further comprise:
determining at least one speed threshold between speed sections of the standard driving cycle based on average speed values in each speed section, and determining a speed range corresponding to each speed section segment using the at least one speed threshold;
comparing an average speed value of the actual driving data with the determined speed threshold;
determining a corresponding speed section based on a speed range in which the average speed value of the actual driving data is located;
after determining the speed section, comparing a maximum speed value of the actual driving data with a maximum speed value of the standard driving cycle in the determined speed section;
evaluating the driving behavior as high energy consumption driving behavior based on the maximum speed value of the actual driving data being greater than the maximum speed value of the standard driving cycle in the determined speed section by a first preset value; and
evaluating the driving behavior as low energy consumption driving behavior based on the maximum speed value of the actual driving data being less than the maximum speed value of the standard driving cycle in the determined speed section by a second preset value.

15. The apparatus of claim 14, wherein the instructions of the at least one processor further comprise:
based on the maximum speed value of the actual driving data which has a difference less than or equal to a first threshold value in comparison with the maximum speed value of the standard driving cycle in the determined speed section, comparing a maximum acceleration value of the actual driving data with a maximum acceleration value of the standard driving cycle in the determined speed section and comparing a maximum deceleration value of the actual driving data with a maximum deceleration value of the standard driving cycle in the determined speed section;
evaluating the driving behavior as high energy consumption driving behavior based on the maximum acceleration value of the actual driving data being greater than the maximum acceleration value of the standard driving cycle in the determined speed section by a third preset value, and the maximum deceleration value of the actual driving data being greater than the maximum deceleration value of the standard driving cycle in the determined speed section by a fourth preset value; and
evaluating the driving behavior as low energy consumption driving behavior based on the maximum acceleration value of the actual driving data being less than the maximum acceleration value of the standard driving cycle in the determined speed section by a fifth preset value, and the maximum deceleration value of the actual driving data being less than the maximum deceleration value of the standard driving cycle in the determined speed section by a sixth preset value.

16. The apparatus of claim 15, wherein the instructions of the at least one processor further comprise:
based on the maximum acceleration value of the actual driving data being greater than the maximum acceleration value of the standard driving cycle in the determined speed section by the third preset value, and the maximum deceleration value of the actual driving data being less than the maximum deceleration value of the standard driving cycle in the determined speed section by the sixth preset value, comparing an acceleration ratio value of the actual driving data with an acceleration ratio value of the standard driving cycle in the determined speed section and comparing a deceleration ratio value of the actual driving data with a deceleration ratio value of the standard driving cycle in the determined speed section;
based on the maximum acceleration value of the actual driving data being less than the maximum acceleration value of the standard driving cycle in the determined speed section by the fifth preset value, and the maximum deceleration value of the actual driving data being greater than the maximum deceleration value of the standard driving cycle in the determined speed section by the fourth preset value, comparing the acceleration ratio value of the actual driving data with the acceleration ratio value of the standard driving cycle in the determined speed section and comparing the deceleration ratio value of the actual driving data with the deceleration ratio value of the standard driving cycle in the determined speed section;
based on the maximum acceleration value of the actual driving data which has a difference less than or equal to a second threshold value in comparison with the maximum acceleration value of the standard driving cycle in the determined speed section, or based on the maximum deceleration value of the actual driving data which has a difference less than or equal to a third threshold value in comparison with the maximum deceleration value of the standard driving cycle in the determined speed section, comparing the acceleration ratio value of the actual driving data with the acceleration ratio value of the standard driving cycle in the determined speed section and comparing the deceleration ratio value of the actual driving data with the deceleration ratio value of the standard driving cycle in the determined speed section;
evaluating the driving behavior as high energy consumption driving behavior based on the acceleration ratio value of the actual driving data being greater than the acceleration ratio value of the standard driving cycle in the determined speed section, and the deceleration ratio value of the actual driving data being less than the deceleration ratio value of the standard driving cycle in the determined speed section; and
evaluating the driving behavior as low energy consumption driving behavior based on the acceleration ratio value of the actual driving data being less than the acceleration ratio value of the standard driving cycle in the determined speed section, and the deceleration ratio value of the actual driving data being greater than the deceleration ratio value of the standard driving cycle in the determined speed section.

17. The apparatus of claim 16, wherein the instructions of the at least one processor further comprise:
based on the driving behavior being evaluated as high energy consumption driving behavior, providing a notification to reduce the speed of the vehicle; and
based on the driving behavior being evaluated as low energy consumption driving behavior, providing a notification to increase the speed of the vehicle.

18. The apparatus of claim 11, wherein the instructions of the at least one processor further comprise providing a difference value between a driving range of the actual driving data and a driving range of the standard driving cycle, wherein the difference value is calculated using:
$${L}_{Δ} = \vert \frac{E \times S}{{\int }_{{t}_{1}}^{{t}_{2}} P} - {L}_{R} \vert$$
wherein L_{Δ} is the difference between the driving range of the actual driving data and the driving range of the standard driving cycle, expressed in kilometers (km),
$$\frac{E \times S}{{\int }_{{t}_{1}}^{{t}_{2}} P}$$
is the driving range of the actual driving data, expressed in kilometers (km), E is a battery capacity, expressed in kilowatt-hours (kWh), P is a battery output energy of the vehicle during driving by the driver from time t₁ to time t₂, and
$${\int }_{{t}_{1}}^{{t}_{2}} P$$
is expressed in kilowatt-hours (kWh), S is a driving distance of the vehicle from time t₁ to time t₂, expressed in kilometers (km), and L_{R} is a driving range measured based on the standard driving cycle corresponding to a vehicle type, expressed in kilometers (km).

19. The apparatus of claim 11, wherein the instructions of the at least one processor further comprise providing a difference value between a driving distance per unit energy of the actual driving data and a driving distance per unit energy of the standard driving cycle, wherein the difference value is calculated using:
$$M = \vert \frac{S}{{\int }_{{t}_{1}}^{{t}_{2}} P} - \frac{{L}_{R}}{E} \vert$$
wherein M is the difference between the driving distance per unit energy of the actual driving data and the driving distance per unit energy of the standard driving cycle, expressed in kilometers per kilowatt-hour (km/kWh), P is a battery output energy of the vehicle during driving by the driver from time t₁ to time t₂, and
$${\int }_{{t}_{1}}^{{t}_{2}} P$$
is expressed in kilowatt-hours (kWh), S is a driving distance of the vehicle from time t₁ to time t₂, expressed in kilometers (km), E is a battery capacity, expressed in kilowatt-hours (kWh), and L_{R} is a driving range measured based on the standard driving cycle corresponding to a vehicle type, expressed in kilometers (km).

20. The apparatus of claim 11, wherein the instructions of the at least one processor further comprise obtaining the parameter values of the actual driving data with respect to the driving characteristics of the standard driving cycle using over-the-air (OTA) technology.
